(19) United States
(12) Patent Application Publication
(10) Pub. No.: US 2011/0011647 A1
(43) Pub. Date: Jan. 20, 2011

(54) Method And Separation Conduit For Handling Lubricant Mist, And Rock Drilling Rig

(75) Inventors: Miikka Mäntyniemi, Ylojarvi (FI); Esa Riihioja, Nokia (FI)

Correspondence Address: DRINKER BIDDLE & REATH (DC), 1500 K STREET, N.W., SUITE 1100, WASHINGTON, DC, 20005-1209, US

(73) Assignee: Sandvik Mining and Construction Oy, Tampere (FI)

(21) Appl. No.: 12/921,179

(22) PCT Filed: Mar. 9, 2009
(86) PCT No.: PCT/FI09/50188

§ 371 Date: Sep. 29, 2010

(30) Foreign Application Priority Data
Mar. 10, 2008 (FI) 20085218

(51) Int. Cl. E21B 15/00; B01D 45/08

(52) U.S. Cl. 175/220; 95/272; 55/444

(57) ABSTRACT

A method for handling lubricant mist used in mist lubrication, a separation conduit and a rock drilling rig having a mist lubrication system provided with a separation conduit. The return flow of the lubrication mist is conveyed in the separation conduit from the lubrication target to a collection container. The separation conduit is an elongated conduit having an elongated separation member arranged therein, the separation member comprising a plural number of successive and inclined barrier surfaces. Lubricant droplets contained in the lubricant mist hit the barrier surfaces and accumulate thereon. The separated lubricant is collected into the collection container at the outermost end of the separation conduit.

### BACKGROUND OF THE INVENTION

The invention relates to a method for collecting lubricant used in mist lubrication, after the lubricant mist has passed over the target of lubrication. The lubricating agent in the lubricant mist is collected into a collection container and compressed air is released into ambient atmosphere.

The invention further relates to a separation conduit and a rock drilling rig, whose mist lubrication system is provided with a separation conduit. The field of the invention is defined in greater detail in the preambles of the independent claims.

It is known in the prior art to lubricate the drill shank of a rock drilling machine with oil mist, in which the oil is in the form of small droplets within compressed air. This type of lubrication is commonly referred to as mist lubrication. When the oil mist has lubricated the drill shank, it is conveyed through a discharge conduit into a collection container, which may be located on the carrier of a rock drilling rig. The collection container is for collecting the oil contained in the oil mist. The compressed air, in turn, is released into ambient atmosphere. For separating oil from air, the outermost end of the discharge conduit is provided with a sieve. In current mist lubrication systems the separation of oil is insufficient, the air released into ambient atmosphere thus still containing plenty of oil droplets that contaminate the breathing air and cause a health risk to those working at the drilling site. Moreover, oil soils the environment and smears the rock drilling rig.

### BRIEF DISCLOSURE OF THE INVENTION

An object of this invention is to provide a novel and improved method and separation conduit for collecting the lubricant used in mist lubrication. A further object of the invention is to provide a novel and improved rock drilling rig.

The method of the invention is characterized by conveying the returning lubricant mist through at least one elongated separation conduit containing at least one elongated separation member provided with a plural number of successive barrier surfaces transverse to the flow direction; separating the lubricant and the compressed air by allowing the lubricant droplets contained in the lubricant mist to hit the barrier surfaces of the separation member; and collecting the separated lubricant from the separation conduit into the collection container.

The separation conduit of the invention is characterized in that inside the separation conduit there is provided at least one elongated separation member comprising a plural number of successive inclined barrier surfaces transverse to the longitudinal axis of the separation conduit.

The rock drilling rig of the invention is characterized in that the mist lubrication system comprises at least one elongated separation conduit provided with at least one elongated separation member, the lubricant and the compressed air being arranged to be separated from one another in the separation conduit; and that the separation member has a plural number of successive inclined barrier surfaces transverse to the flow direction, the lubricant droplets in the lubricant mist being arranged to hit the surfaces and accumulate thereon.

The idea of the invention is that the return flow of the lubricant used in mist lubrication is conveyed through a separation conduit, in which the lubricant and the compressed air contained in the lubricant mist are separated from one another. Inside the separation conduit there is provided an elongated separation member comprising a plural number of successive inclined barrier surfaces transverse to the longitudinal axis of the separation conduit, the lubricant droplets in the lubricant mist being arranged to hit the surfaces and accumulate thereon. The compressed air passes the barrier surfaces without difficulties and pushes, at the same time, the lubricant accumulated on the barrier surfaces forward in the separation conduit.

An advantage of the invention is that it improves the removal and collection of lubricant, whereby ambient air is cleaner and healthier to breath. Moreover, it allows the amount of lubricant spreading to the ground to be reduced. Further still, the smearing of the rock drilling rig may be avoided, which also improves safety at work. A yet further advantage is that the properties of the separation conduit are easy to modify. By changing the length of the separation conduit and the separation member therein and modifying the dimensioning of their diameter it is easy to act on the separation capacity.

According to an embodiment the separation conduit is a flexible hose, such as a standard hydraulic hose with a separate separation member arranged therein. The inner diameter of the hose may be 1 inch, for example. A separation member of this type is simple and inexpensive to manufacture. The length of the separation conduit is fairly easy to dimension according to need. In addition, a flexible hose, even when long, is easy to mount to an apparatus. Also the separation member may be flexible.

According to an embodiment the separation member is a spiral having barrier surfaces of a helical form. The helical barrier surfaces guide the accumulated lubricant and, on the other hand, the compressed air effectively and smoothly forward in the separation conduit.

According to an embodiment the separation member is a spiral formed by rotating a band of a rectangular cross-section around its longitudinal axis for a number of times to provide it with a permanent helical shape. With a suitable rotating device this kind of separation member is extremely easy and inexpensive to manufacture from a metal band, for example. In addition, the properties of the separation member may be easily changed by varying the pitch of the helix, for example.

According to an embodiment the separation conduit is relatively long. The length of the separation conduit may be 1000 mm or more, preferably it is 1000 to 2000 mm. If necessary, the separation conduit may be even longer than 2000 mm. A long separation member allows the lubricant to be removed effectively from the compressed air. Due to the conduit-like structure of the separation member, its length is not disadvantageous, because in any case the returning lubricant mist must be conveyed on some conduit from the drill shank or other lubrication target to the collection container. The separation conduit forms part of the discharge conduit.

According to an embodiment the separation conduit is a hose having a length of 1500 to 2500 mm and an inner diameter of ¾ to 1¼ inches. The separation member is a flexible metal spiral extending from one end of the separation conduit to the other end thereof. The spiral has a rectangular cross-section and it rotates at least eight turns around itself.

### BRIEF DISCLOSURE OF THE FIGURES

Some embodiments of the invention are disclosed in greater detail in the accompanying drawings, in which

FIG. 1 is a schematic side view of a rock drilling rig;

FIG. 2 is a schematic view of a mist lubrication system in connection with a rock drilling machine;

FIG. 3 is a schematic sectional side view of the structure of a separation conduit of the invention;

FIG. 4 is a schematic longitudinal view of the cross-section of the separation conduit of FIG. 3;

FIG. 5 is a schematic longitudinal view of the cross-section of a second separation conduit; and

FIG. 6 is a schematic longitudinal and sectional view of the section of a third separation conduit of the invention.

For the sake of clarity, some embodiments of the invention have been simplified in the Figures. Like parts are referred to with like reference numerals.

### DETAILED DESCRIPTION OF THE INVENTION

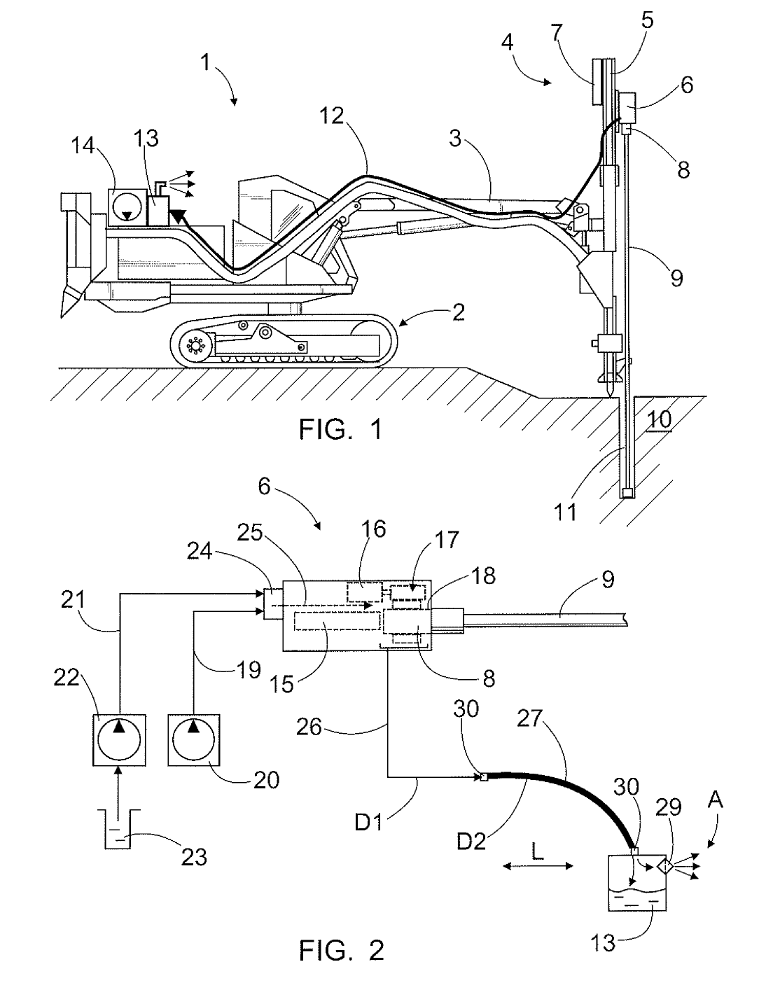

FIG. 1 shows a rock-drilling rig 1 comprising a movable carrier 2 provided with one or more drilling booms 3 having a rock drilling unit 4. The drilling unit 4 comprises a feed beam 5 connected to the drilling boom 3 and a rock-drilling machine 6 that may be moved on the feed beam 5 by means of a feeding device 7. The rock drilling machine 6 has a drill shank 8 whereto a tool 9 may be connected. In some cases the tool is connected directly to the rock drilling machine, without a drill shank. A percussion device of the rock drilling machine 6 is arranged to deliver impact pulses to the tool 9 which transfers them to rock 10, thus breaking the rock and creating a drill hole 11. The drill shank 8 may be lubricated with oil mist. The lubricant mist is formed by dosing a small amount of liquid lubricant into a flow of compressed air. The mist contains small droplets of lubricant, such as oil, mixed with air. When the oil mist has lubricated the bearing surfaces of the drill shank 8 and the rolling surfaces of rotation members, it is collected and conveyed away from the rock drilling machine 6 in a discharge conduit 12 of the collection system. The collection system may include a collection container 13, which may be arranged onto the carrier 2, where it is easy to empty and service. Naturally the collection container 13 may also be placed elsewhere, for example at the foot of the boom 3, onto the ground or any suitable place. The lubricant contained in the oil mist is collected into the collection container 13 and air is discharged into ambient atmosphere. The carrier 2 is provided with the necessary actuators 14 for delivering compressed air and lubricant to the rock drilling machine for mist lubrication.

FIG. 2 shows a mist lubrication system (droplet lubrication, micro lubrication) for lubricating the drill shank 8 of the rock drilling machine 6. A percussion element 15 belonging to the rock drilling machine delivers impact pulses to the shank 8 having the tool 9 connected thereto. The drill shank 8 may be rotated about its longitudinal axis by means of a rotation device 16. Between the drill shank 8 and the rotation device 16 there are provided rotation members 17. The target of mist lubrication in the rock drilling machine 6 may include the bearing surfaces 18 and the rotation members 17 of the drill shank, for example, or any other parts that need lubrication.

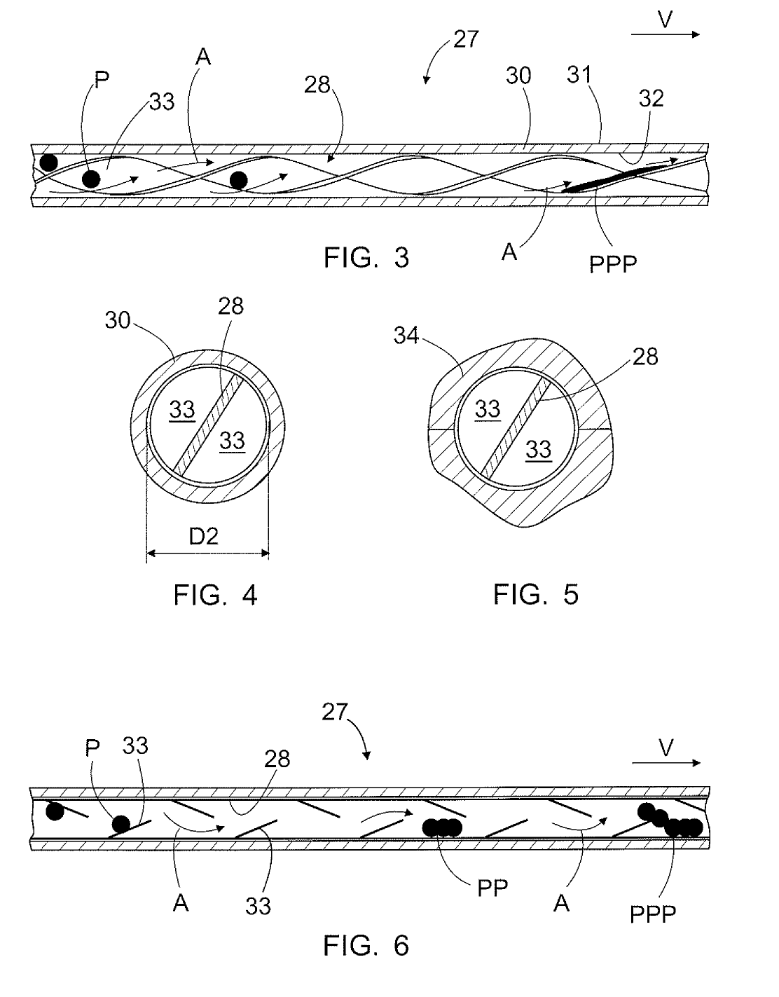

Compressed air may be supplied on a feed conduit 19 from a compressor 20 and lubricant, typically lubricating oil supplied with a pump 22, on a feed conduit 21 from a feed container 23, to the rock drilling machine 6. The rock drilling machine 6 may comprise means 24 combining the lubricant flow with the flow of compressed air to produce a desired lubricant mist, which is then conveyed on a conduit 25 provided in the drilling machine to where lubrication is needed. When the oil mist has passed over the area to be lubricated and accomplished its task, it reaches a return conduit 26 of the collection system. The return conduit 26 has one or more separation conduits 27 coupled thereto, the conduit separating the lubricant contained in the lubricant mist from the compressed air and conveying the separated lubricant liquid and compressed air to the collection container 13. The collection container 13 may be an essentially tight liquid vessel provided with one or more sieves 29 or corresponding members, through which the flow of compressed air is allowed to release from the collection container 13. The sieve 29 may prevent any solid particles and droplets of liquid still remaining in the flow of compressed air from leaving the collection container 13. The separation conduit 27 may be a flexible hose that may be connected to the collection system by means of connecting members 30, or the like, provided at the ends thereof. The inner cross-sectional surface area D2 of the separation conduit 27 may be dimensioned substantially larger than that of a preceding part of the return conduit 26 or a corresponding space. Hence, when the lubricant mist arrives from a space of a smaller cross-sectional surface area to a separation conduit 27 of a larger volume, the flow rate of the lubricant mist decreases, which is advantageous for the separation. Inside the separation conduit 27 there are provided one or more separation members whose surfaces the small lubricant droplets contained in the lubricant mist hit, whereby lubricant accumulates on the surfaces of the separation member, a pressure difference then transferring the lubricant at a slow rate towards the collection container 13. The separation member 28 will be illustrated in FIGS. 3 to 5. The separation conduit 27 may be relatively long to ensure that there is sufficient time for oil or the like contained in the lubricant mist to be separated from the compressed air. The length of the separation conduit 27 may exceed 1000 mm, preferably it is about 2000 mm or even longer. The separation member 28 may be substantially equal in length with the separation conduit 27.

The separation conduit 27 shown in FIG. 3 comprises a cover, which may be a tube or a hose 30 having an annular cross-section and therefore an outer surface 31 and an inner surface 32. It is naturally possible that the cross-section of the separation conduit 27 is other than annular, for example angular or oval. However, from the point of view of manufacturing technology, an annular shape is the most preferred one. Inserted in the hose 30 there is a separation member 28 which may be an elongated band, such as a metal band, having a rectangular cross-section and wound about its longitudinal axis to form a spiral. The separation member 28 is dimensioned so as to be slightly smaller than the inner diameter of the hose 30, which allows it to be inserted into the hose without difficulties. However, the separation member 28 sets against the inner surface 32 of the hose 30 so tightly that oil mist cannot pass the separation member 28 unhandled. The separation member 28 wound into spiral has a plural number of successive helical barrier surfaces 33 which the tiny lubricant droplets P contained in the oil mist flow hit. Hence lubricant starts to accumulate on the barrier surface 33, from where it continues pushed by compressed air A in flow direction V towards the collection container. The helical barrier surfaces 33 are inclined towards flow direction V and therefore they do not impair the movement of the collected lubricant in flow direction V, but both the liquid flow and the flow of the compressed air may take place smoothly in the separation conduit. The properties of the separation conduit 27 are easy to dimension to suit different applications by varying length L and inner diameter D2 of the hose 30, for example, and also by selecting a desired type of separation member 28. The number of the turns of the separation member 28 in proportion to length L may be varied. For example, the hose 30 may be a normal hydraulic hose. Also the separation member 28 may be flexible.

The separation conduit 27 shown in FIG. 5 is neither a hose nor a tube, but some other body piece 34 with a relatively long space which accommodates the separation member 28 and through which the lubricant mist flow returning from the lubricated area is conveyed. The separation member 28 may be a screw, similar to the one shown in FIGS. 3 and 4, or some other elongated piece suitable for the purpose.

FIG. 6 shows yet another possible application, in which a substantially tubular separation member 28 has been arranged inside the hose 30, the member comprising inclined barrier surfaces 33 which protrude towards the interior thereof and which the lubricant mist flow and the lubricant droplets contained therein hit. The figure shows how the droplets accumulated onto the barrier surfaces 33 start growing into larger lubricant accumulations PP and finally to a liquid flow PPP that proceeds at a slow rate in flow direction V towards the collection container.

Further, the separation member may form into the separation conduit kind of a labyrinth with a plural number of inclined barrier surfaces for collecting oil droplets. In some cases the separation member may be an elongated, wavelike piece.

It is also possible to produce the separation member by casting it from plastic, for example. Further, the separation member may be made of a composite consisting of one more plastic materials and one or more reinforcing materials. Yet another possibility is that the separation member forms a uniform structure with the cover part of the separation conduit.

Naturally it is possible that the oil mist collection system of the invention is used not only in rock drilling machines but also for lubricating bearings and other moving parts of other rock breaking equipment provided with a percussion device. Examples of other rock breaking equipment include breaking hammers, in which a percussion device is used for generating impact pulses to a tool that is used for breaking rock, stone blocks, frozen ground or some other hard material. The bearing on the top of a breaking hammer tool, for example, may be mist lubricated. Also in that case it is possible to collect the lubrication mist with a collection system of the type described above and separate the lubricant and air from one another in a separation conduit. Further, the mist lubrication system of any moving machine part may be provided with a separation conduit of the invention.

In some cases the features of this application may be used as such, irrespective of the other features. On the other hand, the features disclosed here may be combined, when necessary, to provide different combinations.

The drawings and the related specification are only intended to illustrate the inventive idea. The details of the invention may vary within the scope of the claims.

1. A method for handling lubricant used in mist lubrication, the method comprising
collecting lubricant mist consisting of compressed air and lubricant at a lubrication target and conveying it through a return conduit towards a collection container,
separating the lubricant from the lubricant mist into the collection container,
allowing the compressed air to release into ambient atmosphere,
conveying the returning lubricant mist through at least one elongated separation conduit containing at least one elongated separation member provided with a plural number of successive inclined barrier surfaces transverse to the flow direction,
separating the lubricant and the compressed air by allowing the lubricant droplets in the lubricant mist to hit the barrier surfaces in the separation member,
and collecting the separated lubricant from the separation conduit into the collection container.

2. A method according to claim 1, comprising
using a separation conduit having a spiral separation member,
and collecting the lubricant droplets contained in the lubricant mist on the helical barrier surfaces of the spiral separation member.

3. A method according to claim 1, comprising conveying the returning lubricant mist from a conduit part having a smaller cross-sectional surface to a separation conduit having a larger cross-sectional surface, whereby the flow rate of the lubricant mist reduces when the separation conduit is entered in proportion to the change in the cross-sectional surfaces.

4. A method according to claim 1, comprising handling in the separation conduit the return flow of the lubricant mist used for lubricating the lubrication target in the rock drilling machine.

5. A separation conduit for lubricant mist, comprising
an elongated conduit through which the return flow of the lubricant mist returning from the lubrication target may be conveyed,
and at least one elongated separation member inside the separation conduit comprising a plural number of successive inclined barrier surfaces transverse to the longitudinal axis of the separation conduit.

6. A separation conduit according to claim 5, wherein the separation conduit is a flexible hose.

7. A separation conduit according to claim 5, wherein the length of the separation conduit is at least 1000 mm.

8. A separation conduit according to claim 5, wherein
the separation conduit is a helical piece comprising an elongated band having a rectangular cross-section, the band making a plural number of turns about its longitudinal axis,
and the helical surfaces of the separation member are arranged to act as inclined barrier surfaces, the lubricant droplets being arranged to hit them and accumulate thereon.

9. A separation conduit according to claim 5, wherein the cross-section of the separation conduit is annular and its diameter is at least 20 mm.

10. A rock drilling rig comprising:
a movable carrier,
least one drilling boom arranged onto the carrier,
a rock drilling unit arranged to the drilling boom, the rock drilling unit comprising a feed beam and a rock drilling machine, which is movable on the feed beam with a feeding device and in which the rock drilling machine comprises a percussion device for generating impact pulses to a tool, and
a mist lubrication system comprising: feed conduits for feeding compressed air and lubricant to the rock drilling machine, means for mixing compressed air and lubricant into lubricant mist and for delivering it to the lubrication target, at least one conduit for conveying the lubricant mist away from the lubrication target after the lubrication, means for separating the lubricant from the compressed air, and, further, a collection container for collecting the separated lubricant,
wherein the mist lubrication system comprises at least one elongated separation conduit provided with at least one elongated separation member, the lubricant and the compressed air being arranged to be separated from one another in the separation conduit,
and the separation member has a plural number of successive inclined barrier surfaces transverse to the flow direction, the lubricant droplets in the lubricant mist being arranged to hit them and accumulate thereon.

11. A rock drilling rig according to claim 10, wherein the inner cross-sectional area of the separation conduit is at least double the inner cross-sectional area of the discharge conduit part upstream of the separation conduit.

12. A rock drilling rig according to claim 10, wherein
the outermost end of the separation conduit is arranged into a closed collection container on the carrier, and
in connection with the collection container there is provided at least one sieve through which the compressed air separated from the lubricant mist is allowed to discharge into ambient atmosphere.
